(19) United States
(12) Patent Application Publication
(10) Pub. No.: US 2010/0017455 A1
(43) Pub. Date: Jan. 21, 2010

(54) CUSTOMIZED MEDIA BROADCAST FOR A BROADCAST GROUP

(75) Inventors: Hugh Svendsen, Chapel Hill, NC (US); Gregory M. Evans, Raleigh, NC (US); Harold Sutherland, San Jose, CA (US)

Correspondence Address: WITHROW & TERRANOVA CT, 100 REGENCY FOREST DRIVE , SUITE 160, CARY, NC, 27518, US

(73) Assignee: LEMI TECHNOLOGY, LLC, WILMINGTON, DE (US)

(21) Appl. No.: 12/174,870

(22) Filed: Jul. 17, 2008

(51) Int. Cl. G06F 15/16

(52) U.S. Cl. 709/202

(57) ABSTRACT

Methods and systems are provided for delivering a customized media broadcast to a social group of users referred to as a broadcast group. In general, a broadcast group including a number of users is identified. User profiles of the users forming the broadcast group are obtained and aggregated to provide a group profile for the broadcast group. More specifically, in one embodiment, the users forming the broadcast group are weighted, and the user profiles of the users are then aggregated according to the weights assigned to the corresponding users to provide the group profile of the broadcast group. A customized media broadcast is then delivered to the users forming the broadcast group based on the group profile of the broadcast group.

### FIELD OF THE INVENTION

The present invention relates to providing a customized media broadcast to a group of users.

### BACKGROUND OF THE INVENTION

With the proliferation of digital media content and the popularity of social networking services, there is a desire for new ways in which users can experience media content in a social context.

### SUMMARY OF THE INVENTION

The present invention relates to providing customized data to a social group of users. In the preferred embodiment, the present invention relates to providing a customized media broadcast to a social group of users referred to as a broadcast group. In general, a broadcast group including a number of users is identified. User profiles of the users forming the broadcast group are obtained and aggregated to provide a group profile for the broadcast group. More specifically, in one embodiment, the users forming the broadcast group are weighted. The users forming the social group may be weighted as a function of, for example, their distances from a group center of the broadcast group; their social network relationships; or the like. The user profiles of the users may then be aggregated according to the weights assigned to the corresponding users to provide the group profile of the broadcast group. A customized media broadcast is then delivered to the users forming the broadcast group based on the group profile of the broadcast group. The customized media broadcast may include customized media content selected based on the group profile, customized advertisement content selected based on the group profile, or both customized media content and customized advertisement content selected based on the group profile.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a flow chart illustrating a process for delivering a customized media broadcast to a number of users forming a broadcast group according to one embodiment of the present invention;

FIGS. 2 and 3 graphically illustrate an exemplary process for weighting the users in the broadcast group based on distances of the users from a group center of the broadcast group according to one embodiment of the present invention;

FIGS. 4 and 5 graphically illustrate an exemplary process for weighting the users in the broadcast group based on user relationships according to one embodiment of the present invention;

FIGS. 6A and 6B illustrate exemplary user profiles of the users in the broadcast group and a group profile of the broadcast group resulting from aggregating the user profiles of the users according to the weights assigned to the users according to one embodiment of the present invention;

FIG. 7 illustrates a system for delivering a customized media broadcast to users in a broadcast group according to a first exemplary embodiment of the present invention;

FIG. 8 illustrates the operation of the system of FIG. 7 according to one embodiment of the present invention;

FIG. 9 illustrates a system for delivering a customized media broadcast to users in a broadcast group according to a second exemplary embodiment of the present invention;

FIG. 10 illustrates the operation of the system of FIG. 9 according to one embodiment of the present invention;

FIG. 11 is a block diagram of an exemplary embodiment of the content server of FIG. 7;

FIG. 12 is a block diagram of an exemplary embodiment of one of the media playback devices of FIGS. 7 and 9; and

FIG. 13 is a block diagram of an exemplary embodiment of the negotiation server of FIG. 9.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

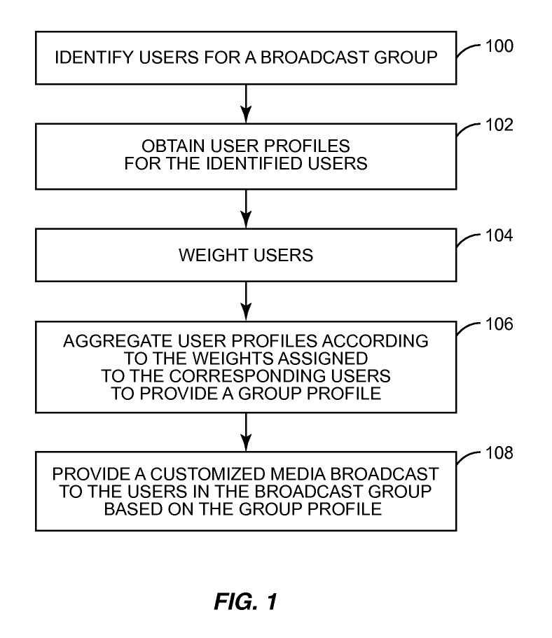

FIG. 1 illustrates a process for providing a customized media broadcast to users in a social group according to one embodiment of the present invention. Note that while the discussion herein focuses on providing a customized media broadcast to users in a social group, the present invention is not limited thereto. Other types of customized data may additionally or alternatively be provided to users in the social group. For example, in addition to or as an alternative to a customized media broadcast, a customized Really Simple Syndication, RDF Site Summary, Rich Site Summary feed, generally referred to as an RSS feed, may be provided to the group.

First, users are identified for a social group for delivery of a customized media broadcast (step 100). The social group for delivery of a customized media broadcast is hereinafter referred to as a broadcast group. In general, the users for the broadcast group may be identified in any suitable manner. In one embodiment, a user participating in a social networking activity, such as a chat session, may initiate creation of the broadcast group. In response, one or more other users participating in the social networking activity may be prompted or otherwise queried to determine whether they desire to join the broadcast group. In another embodiment, a user may initiate creation of the broadcast group. In response, one or more other users having a social relationship with the user may be prompted or otherwise queried to determine whether they desire to join the broadcast group. For example, the other users may be users in a contact list of the user initiating the broadcast group. The contact list may be, for example, an email contact list, an instant messaging buddy list, a contact list maintained by a mobile phone of the user, a contact list of the user maintained by a social networking service such as a social networking website, or the like. The user initiating the creation of the broadcast group and the other users that choose to join the broadcast group are then identified as the users for the broadcast group.

Next, user profiles for the users in the broadcast group are obtained (step 102). For each user, the user profile of the user preferably includes media preferences and demographic information. The media preferences may include information identifying one or more preferred music genres, one or more preferred music artists, one or more preferred decades or similar time periods of music, one or more preferred video genres, one or more preferred actors or actresses, one or more preferred video directors, or the like. For example, in one embodiment, the media preferences include weights assigned to each of a number of music genres, weights assigned to each of a number of music artists, weights assigned to each of a number of decades or similar time periods of music, weights assigned to each of a number of video genres, weights assigned to each of number of actors or actresses, weights assigned to each of a number of video directors, or the like. The weights may be assigned by the user or automatically assigned based on, for example, an analysis of songs in a media collection of the user, a play history of the user, a purchase history of the user identifying songs previously purchased by the user, or the like. The demographic information may include, for example, age, gender, income level, or the like. In addition, the user profile may include a purchase history of the user including information identifying media items previously purchased by the user as well as information identifying non-media items previously purchased by the user. The purchase history of the user may be used to identify purchase habits of the user. Lastly, the user profile may include a home address, or mailing address, of the user.

In addition, in this embodiment, the users in the broadcast group are weighted (step 104). In one embodiment, the users are weighted as a function of their distances from a group center of the users forming the broadcast group. Preferably, the users are assigned weights that are inversely related to their distances from the group center. As such, users closer to the group center are weighted the highest.

More specifically, in order to weight the users based on their distances from the group center, a location of each user in the broadcast group is obtained. The locations of the users may be obtained using any desired technique. For example, in one embodiment, the users are equipped with mobile devices such as, but not limited to, mobile smart phones equipped with Global Positioning System (GPS) receivers. The locations of the mobile devices may then be obtained from the mobile devices and utilized as the locations of the users. As another alternative, the users may be equipped with mobile devices such as, but not limited to, mobile smart phones where tower triangulation may be used to determine the locations of the mobile devices and thus the users. Once the locations of the users in the broadcast group are obtained, the group center is determined. In one embodiment, the group center is a center of gravity of the broadcast group and determined based on the following equation:

$$GroupCenter = \frac{1}{N} \cdot {\sum }_{i = 1}^{N} {r}_{i} , \qquad Equation ( 1 )$$

where GroupCenter is the group center, N is the number of users in the broadcast group, and rᵢ is the location of the i^{th} user with respect to a predefined reference point expressed rᵢ=xᵢ*i+yᵢ*j. Equation (1) may be re-written such that the group center is expressed in terms of an x-component and a y-component:

$${GroupCenter}_{X} = \frac{1}{N} \cdot {\sum }_{i = 1}^{N} {x}_{i} , and \qquad Equation ( 2 )$$

$${GroupCenter}_{Y} = \frac{1}{N} \cdot {\sum }_{i = 1}^{N} {y}_{i} , \qquad Equation ( 3 )$$

where GroupCenter_{X} and GroupCenter_{Y} define the group center in Cartesian coordinates, N is the number of users in the broadcast group, and xᵢ and yᵢ define the location of the i^{th} user with respect to a predefined point in Cartesian coordinates. For each user, a distance between the user and the group center is then determined. The users are then weighted based on their distances from the group center.

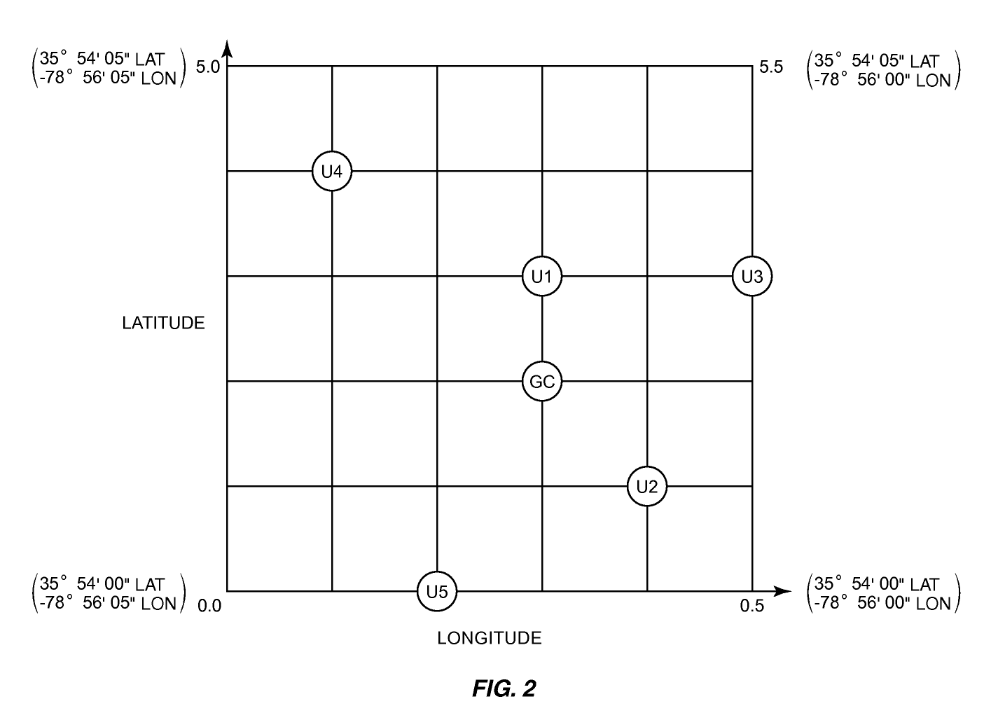

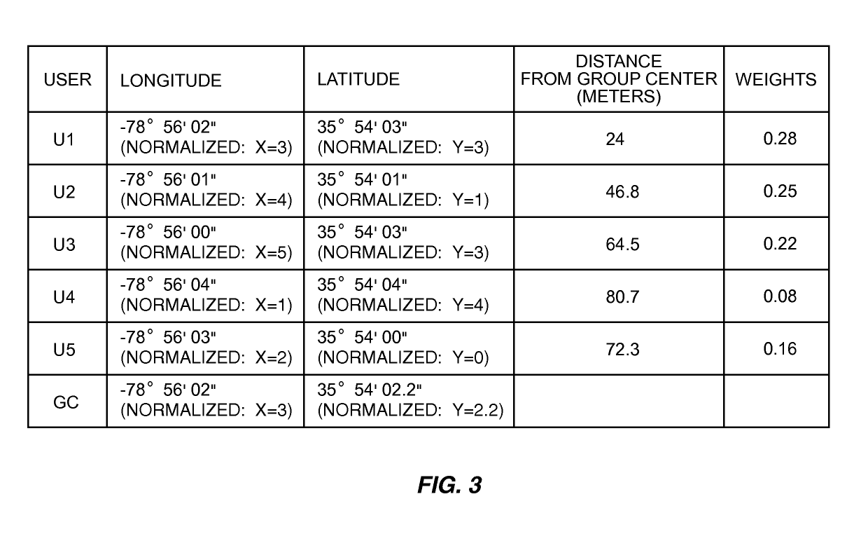

As an example, referring to FIG. 2, the users identified for the broadcast group (U1 through U5) are illustrated. The locations of the users U1 through U5 in terms of latitude and longitude have been normalized to a reference point of 35° 54′ 00″ Latitude and −78° 56′ 05″ Longitude. As such, the origin (0,0) of the illustrated graph corresponds to the reference point of 35° 54′ 00″ Latitude and −78° 56′ 05″ Longitude. The group center is then determined based on Equations (2) and (3) from above. In this example, the group center is 35° 54′ 02.2″ Latitude and −78° 56′ 02″ Longitude, which when normalized is x=3, y=2.2 on the illustrated graph. More specifically, FIG. 3 is a table providing the locations of the users U1 through U5. As such, using the normalized values for the longitude components of the locations of the users U1 through U5:

$${GroupCenter}_{X} = \frac{1}{N} \cdot {\sum }_{i = 1}^{N} {x}_{i} = \frac{1}{5} \cdot ( 3 + 4 + 5 + 1 + 2 ) = 3 ,$$

where a normalized value of x=3 in this example corresponds to −78° 56′ 02″ Longitude. Likewise, using the normalized values for the latitude components of the locations of the users U1 through U5:

$${GroupCenter}_{Y} = \frac{1}{N} \cdot {\sum }_{i = 1}^{N} {y}_{i} = \frac{1}{5} \cdot ( 3 + 1 + 3 + 4 + 0 ) = 2.2 ,$$

where a normalized value of y=2.2 in this example corresponds to 35° 54′ 02.2″ Latitude. As such, the group center in this example is 35° 54′ 02.2″ Latitude and −78° 56′ 02″ Longitude. Note that the group center is not limited to being the center of gravity of the broadcast group. Other schemes for determining the group center based on the locations of the users in the broadcast group will be apparent to one of ordinary skill in the art upon reading this disclosure and are to be considered within the scope of the present invention.

Once the group center is known, for each user of the users U1 through U5, the distance of the user from the group center is determined. In this example, the distance from the user U1 to the group center is 24 meters, the distance from the user U2 to the group center is 46.8 meters, the distance from the user U3 to the group center is 64.5 meters, the distance from the user U4 to the group center is 80.7 meters, and the distance from the user U5 to the group center is 72.3 meters. In this example, the weights for the users U1 through U5 are determined by first determining a value for each user based on the equation:

$${value}_{i} = \frac{{D}_{i}}{{\sum }_{i = 1}^{N} {D}_{i}} , \qquad Equation ( 4 )$$

where Dᵢ is the distance from the i^{th} user to the group center and N is the number of users, which in this example is five (5). Using Equation (4), the following values are provided:

TABLE 1

| User | Distance (D) | Value |
|---|---|---|
| U1 | 24 | 0.08 |
| U2 | 46.8 | 0.16 |
| U3 | 64.5 | 0.22 |
| U4 | 80.7 | 0.28 |
| U5 | 72.3 | 0.25 |

In order to assign weights to the users U1 through U5 that are inversely related to the distances of the users U1 through U5 from the group center, in this example, the values determined using Equation (4) and illustrated in Table 1 are assigned as weights of the users U1 through U5 such that the highest value is assigned as the weight of the user closest to the group center, which in this example is the user U1; the next highest value is assigned as the weight of the next closest user to the group center, which in this example is the user U2; etc. Accordingly, the weights are assigned as shown in Table 2.

TABLE 2

| User | Distance (D) | Value | Weight |
|---|---|---|---|
| U1 | 24 | 0.08 | 0.28 |
| U2 | 46.8 | 0.16 | 0.25 |
| U3 | 64.5 | 0.22 | 0.22 |
| U4 | 80.7 | 0.28 | 0.08 |
| U5 | 72.3 | 0.25 | 0.16 |

As a result, the users U1 through U5 are assigned weights that are inversely related to their distances from the group center.

Note that the process discussed above for assigning weights to the users U1 through U5 based on the distances of the users U1 through U5 from the group center is exemplary. Numerous alternative schemes for determining the weights to assign to the users in the broadcast group based on the distances of the users U1 through U5 from the group center will be apparent to one of ordinary skill in the art and are to be considered within the scope of the present invention. For example, as one alternative, the weights may be assigned to the users in the broadcast group using the following equation:

$${weight}_{i} = \frac{1}{{D}_{i}} \cdot \frac{1}{{\sum }_{i = 1}^{N} \frac{1}{{D}_{i}}} , \qquad Equation ( 5 )$$

where weightᵢ is the weight assigned to the i^{th} user, Dᵢ is the distance between the i^{th} user and the group center, and N is the number of users in the broadcast group. Using Equation (5), the following weights may be assigned to the users U1 through U5 from the example above:

TABLE 3

| User | Distance (D) | Weight |
|---|---|---|
| U1 | 24 | 0.40 |
| U2 | 46.8 | 0.20 |
| U3 | 64.5 | 0.15 |
| U4 | 80.7 | 0.12 |
| U5 | 72.3 | 0.13 |

Returning to step 104 of FIG. 1, in another embodiment, the users in the broadcast group may be weighted as a function of one or more social criteria. For example, the one or more social criteria may be defined based upon contacts in a contact list of the user such as an email contact list, an instant messaging buddy list, a contact list maintained by a mobile phone of the user, a contact list of the user maintained by a social networking service, or the like. More specifically, the one or more social criteria may include one or more of a number of contacts of the user, a number of the contacts of the user that are also in the broadcast group (“in network” friends or contacts), and a number of the contacts of the user that are not in the broadcast group (“out of network” friends or contacts). As another example, the one or more social criteria may be defined with respect to a social network of the user hosted by a social networking service such as a social networking website, wherein the social network defines both direct social network relationships (e.g., contacts or friends) and indirect social network relationships (e.g., contacts-of-contacts or friends-of-friends). More specifically, the one or more social criteria may include one or more of a number of direct or indirect social network relationships of the user, a number of direct social network relationships of the user, a number of indirect social network relationships of the user, a number of other users in the broadcast group with which the user has a direct social network relationship (“in network” friends or contacts), a number of other users that are not in the broadcast group and with which the user has a direct social network relationship (“out of network” friends or contacts), a number of other users in the broadcast group with which the user has an indirect social network relationship, and a number of other users that are not in the broadcast group and with which the user has an indirect social network relationship.

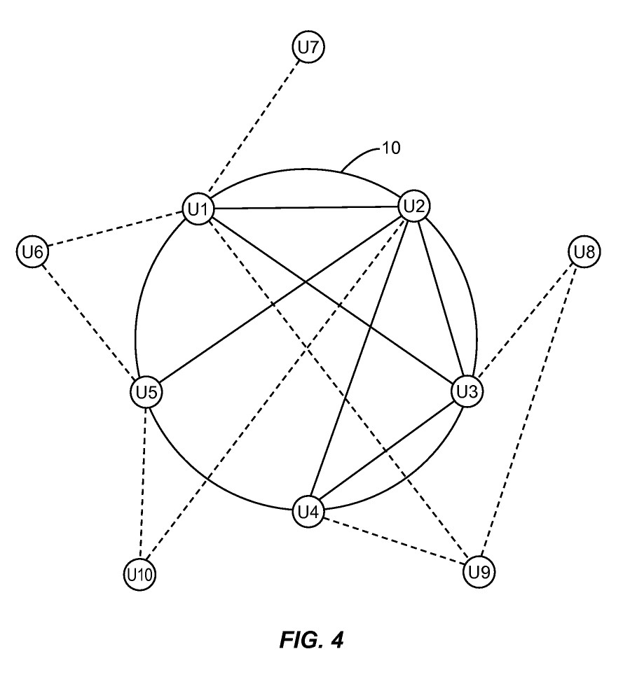

As an example, FIG. 4 graphically illustrates a broadcast group 10 including users U1 through U5. Users U6 through U10 are also illustrated and are users that are not in the broadcast group 10 but have social network relationships with one or more of the users U1 through U5 in the broadcast group 10. Note that solid lines represent relationships between the users U1 through U5 in the broadcast group 10, which are also referred to herein as “in network” relationships. Dashed lines represent relationships with users outside of the broadcast group 10, which are also referred to herein as “out of network” relationships. As such, the user U1 has direct “in network” social network relationships with the users U2 and U3, and direct “out of network” social network relationships with the users U6, U7, and U9. The users U2, U3, U6, U7, and U9 may also be referred to herein as contacts or friends of the user U1. Likewise, the user U2 has direct “in network” social network relationships with the users U1, U3, U4, and U5 and a direct “out of network” social network relationship with the user U10. The user U3 has direct “in network” social network relationships with the users U1, U2, and U4 and a direct “out of network” social network relationship with the user U8. The user U4 has direct “in network” social network relationships with the users U2 and U3 and a direct “out of network” social network relationship with the user U9. Lastly, the user U5 has a direct “in network” social network relationship with the user U2 and direct “out of network” social network relationships with the users U6 and U10.

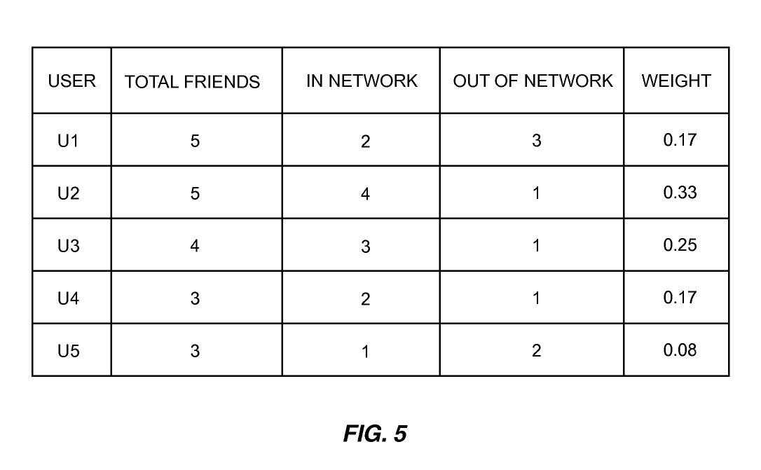

FIG. 5 is a table providing the total number of friends or contacts of each of the users U1 through U5 in the broadcast group 10 of FIG. 4, the number of “in network” friends or contacts of each of the users U1 through U5 in the broadcast group 10, the number of “out of network” friends or contacts of each of the users U1 through U5 in the broadcast group 10, and weights assigned to the users U1 through U5. In this example, the weights are assigned to the users U1 through U5 using the following equation:

$${weight}_{i} = \frac{{InNetwork\_Friends}_{i}}{{\sum }_{i = 1}^{N} {InNetwork\_Friends}_{i}} , \qquad Equation ( 6 )$$

where weightᵢ is the weight assigned to the i^{th} user, InNetwork_Friendsᵢ is the number of “in network” friends or contacts of the i^{th} user, and N is the number of users.

Note that Equation (6) is exemplary and not intended to limit the scope of the present invention. With respect to FIGS. 4 and 5, the weights assigned to the users U1 through U5 in the broadcast group 10 may be a function of the total number of friends of each of the users U1 through U5, the number of “in network” friends of each of the users U1 through U5, the number of “out of network” friends of each of the users U1 through U5, or a combination thereof. For example, the weights may alternatively be assigned to the users U1 through U5 using the following equations:

$${INweight}_{i} = \frac{{InNetwork\_Friends}_{i}}{{\sum }_{i = 1}^{N} {InNetwork\_Friends}_{i}} , \\ {OUTweight}_{i} = \frac{Out\_of \_Network {\_Friends}_{i}}{{\sum }_{i = 1}^{N} Out\_of \_Network {\_Friends}_{i}} , \\ and$$

$${weight}_{i} = A \cdot {INweight}_{i} - B \cdot {OUTweight}_{i} ,$$

where weightᵢ is the weight assigned to the i^{th} user, InNetwork_Friendsᵢ is the number of “in network” friends or contacts of the i^{th} user, Out_of_Network_Friendsᵢ is the number of “out of network” friends or contacts of the i^{th} user, and N is the number of users. Further, A and B are user-defined or system-defined weighting values, where A+B preferably equals one (1).

Returning to step 104 of FIG. 1, in addition or alternatively, the weights assigned to the users in the broadcast group may be a function of demographic information such as income level, age, gender, or the like. For example, those users having demographic information identifying them as being of higher interest to potential advertisers may be assigned greater weights. For example, users having higher income levels may be assigned greater weights. Still further, the weights assigned to the users in the broadcast group may additionally or alternatively be a function of the media preferences of the users, the locations of the users, the status of the users (e.g., online or offline), or the like. It should also be noted that while the discussion above focuses on the situations where the users are weighted based on distance from the group center (FIGS. 2 and 3) or social network relationships (FIGS. 4 and 5), the users may be weighted as a function of both the distances of the users from the group center and their social network relationships.

Still further, the weights assigned to the users in the broadcast group may additionally or alternatively be a function of an amount of time each of the users in the broadcast group has participated in the broadcast group. This may be particularly beneficial where users are enabled to dynamically join and exit the broadcast group. For example, once the users have chosen to join the broadcast group, the users may log-in or log-out of the broadcast group as desired. As such, users that have been logged-in to the broadcast group the longest may be assigned greater weights.

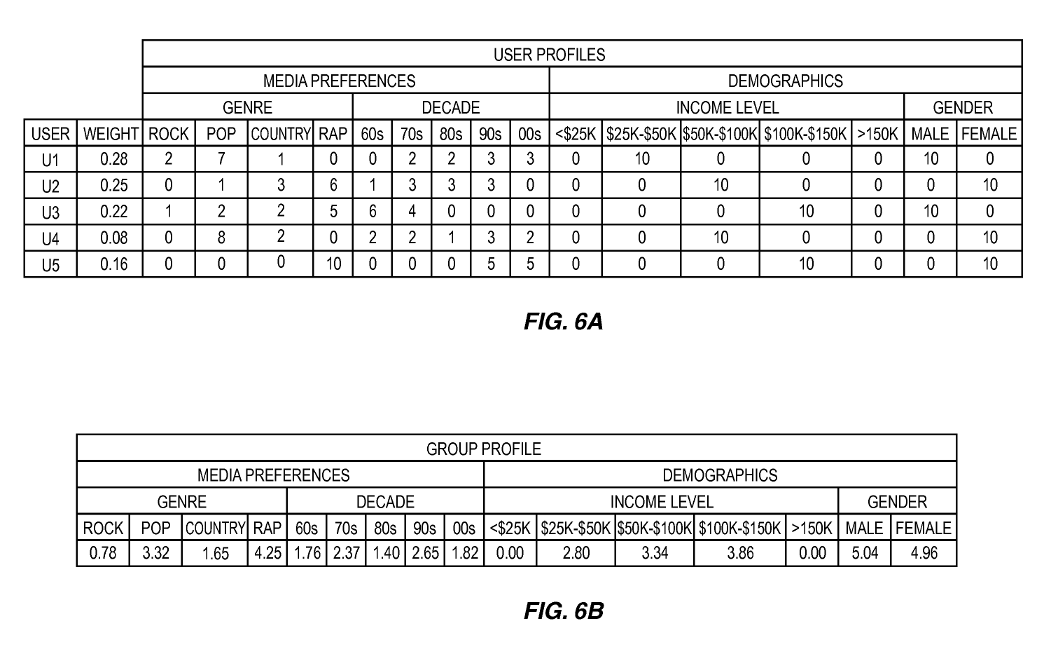

Once the users in the social group are weighted, the user profiles of the users in the broadcast group are aggregated according to the weights assigned to the corresponding users to provide a group profile for the broadcast group (step 106). Continuing the example from FIGS. 2 and 3, FIGS. 6A and 6B illustrate the aggregation of the user profiles of the exemplary users U1 through U5 according to the weights assigned to the users U1 through U5 as a function of their distances from the group center. Note, however, that this same aggregation process may be used regardless of how the weights are assigned to the users U1 through U5. FIG. 6A is a table illustrating exemplary user profiles of the users U1 through U5. As illustrated, the user profile of each of the users U1 through U5 includes media preferences, which in this example are represented as weights assigned to each of a number of music genres and weights assigned to each of a number of decades. In addition, the user profile of each of the users U1 through U5 includes demographics, which again are represented as numerical values or weights. Thus, looking at the user U1, the income level of the user U1 is $25,000 to $50,000 annually. As such, that income level range is assigned a weight of 10 out of a possible 10 and all other income level ranges are assigned weights of 0 out of a possible 10. Likewise, since the user U1 is a male, the male gender is assigned a weight of 10 and the female gender is assigned a weight of 0.

FIG. 6B illustrates a group profile resulting from the aggregation of the exemplary user profiles of the users U1 through U5 illustrated in FIG. 6A according to the weights assigned to the users U1 through U5. In this example, the group profile includes media preferences for the broadcast group represented as aggregate weights for each of a number of music genres and decades, and demographics for the broadcast group represented by aggregate weights assigned to each of a number of income levels and genders. Using the Rock music genre as an example, the aggregate weight assigned to the Rock music genre for the group profile is determined using the following equation:

$${AggregateWeight}_{ROCK} = {\sum }_{i = 1}^{N} {weight}_{i} \cdot {weight}_{ROCK , i} , \qquad Equation ( 7 )$$

where AggregateWeight_{ROCK} is the aggregate weight for the Rock music genre for the group profile, weightᵢ is the weight assigned to the i^{th} user, and weight_{ROCK,i} is the weight assigned to the Rock music genre in the user profile of the i^{th} user. Thus, using Equation (7), the aggregate weight for the Rock music genre for the group profile is:

AggregateWeight_{ROCK}=(0.28·2)┤(0.25·0)┤(0.22·1)┤(0.08·0)┤(0.16·0)=0.78.

Likewise, the aggregate weights for the remaining media preferences and demographics may be determined for the group profile of the broadcast group.

Returning to FIG. 1, after the user profiles of the users in the broadcast group are aggregated to provide the group profile, a customized media broadcast is provided to the users in the broadcast group based on the group profile (step 108). In one embodiment, the customized media broadcast includes media content and advertisements. The media content, advertisements, or both the media content and the advertisements in the customized media broadcast may be selected based on the group profile of the broadcast group. In general, the customized media content is generated or otherwise obtained based on the group profile of the broadcast group using any suitable technique.

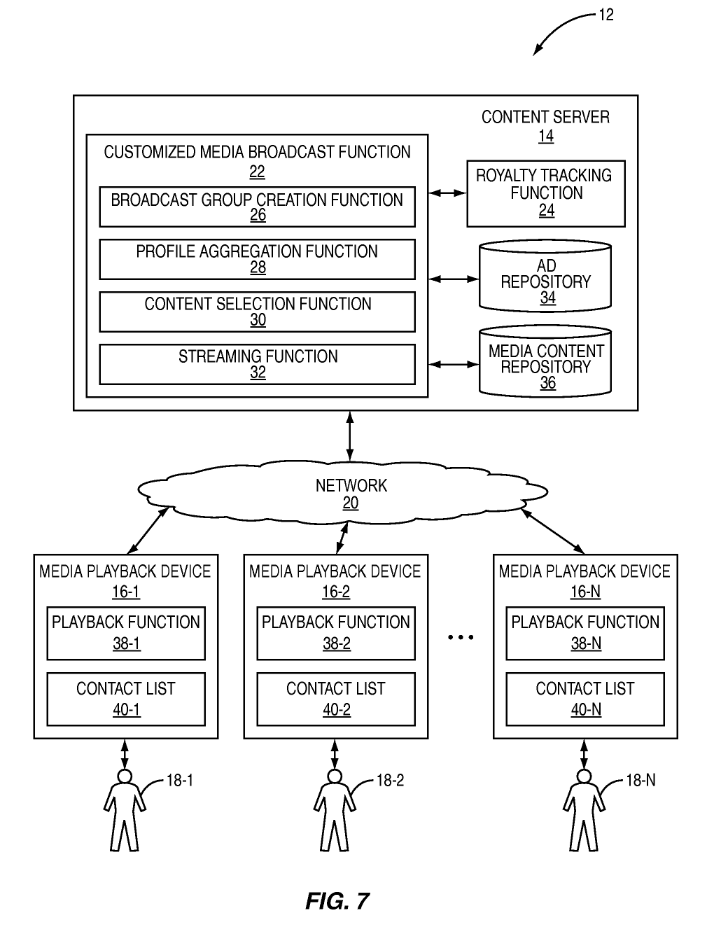

FIG. 7 illustrates a system 12 for providing a customized media broadcast to a broadcast group according to one exemplary embodiment of the present invention. In general, the system 12 includes a content server 14 and a number of media playback devices 16-1 through 16-N having associated users 18-1 through 18-N. The content server 14 is connected to the media playback devices 16-1 through 16-N via a network 20. The network 20 may be any type of Wide Area Network (WAN), Local Area Network (LAN), or any combination thereof. In addition, the network 20 may include wired components, wireless components, or both wired and wireless components. For example, the network 20 may be the Internet. As another example, the network 20 may be a 2G, 3G, 3.5G, WiMAX, or Long Term Evolution (LTE) wireless communications network.

The content server 14 includes a customized media broadcast function 22 and optionally a royalty tracking function 24, each of which may be implemented in software, hardware, or a combination thereof. In this embodiment, the customized media broadcast function 22 includes a broadcast group creation function 26, a profile aggregation function 28, a content selection function 30, and a streaming function 32. The broadcast group creation function 26 generally operates to identify two or more users from the users 18-1 through 18-N for a broadcast group. The profile aggregation function 28 then assigns weights to the users forming the broadcast group, obtains user profiles of the users forming the broadcast group, and aggregates the user profiles of the users forming the broadcast group according to the weights assigned to the users forming the broadcast group to provide a group profile for the broadcast group. The content selection function 30 then selects advertisements and media content for a customized media broadcast for the broadcast group from an advertisement (“ad”) repository 34 and a media content repository 36, respectively, based on the group profile for the broadcast group. In this embodiment, the streaming function 32 then delivers media content and advertisements forming the customized media broadcast to media playback devices of the media playback devices 16-1 through 16-N of the users forming the broadcast group. More specifically, in one embodiment, the streaming function 32 streams the customized media broadcast to the media playback devices of the users in the broadcast group via a multicast communication channel. The multicast communication channel may be provided according to the Internet Protocol version 6 (IPv6). The royalty tracking function 24 generally operates to track delivery of the media items from the media content repository 36 such that appropriate royalties are paid to the corresponding owners of the media content.

The ad repository 34 includes a number of advertisements such as, for example, audio or video advertisements that may be utilized when creating customized media broadcasts. The media content repository 36 includes a number of media items such as songs, videos, or the like that may be utilized when creating customized media broadcasts. Note that while the ad repository 34 and the media content repository 36 are illustrated as being hosted by the content server 14, the present invention is not limited thereto. The ad repository 34 and/or the media content repository 36 may be completely or partially hosted by one or more remote sources and accessible to the content server 14.

The media playback devices 16-1 through 16-N may be, for example, personal computers, mobile smart phones having media playback capabilities, portable media players having network capabilities, set-top boxes, or the like. Using the media playback device 16-1 as an example, the media playback device 16-1 includes a playback function 38-1, which may be implemented in software, hardware, or a combination thereof. In addition, in this example, the media playback device 16-1 hosts a contact list 40-1 of the user 18-1. The contact list 40-1 identifies one or more other users from the users 18-2 through 18-N that are contacts or friends of the user 18-1. Likewise, the media playback devices 16-2 through 16-N include playback functions 38-2 through 38-N and host contact lists 40-2 through 40-N, respectively.

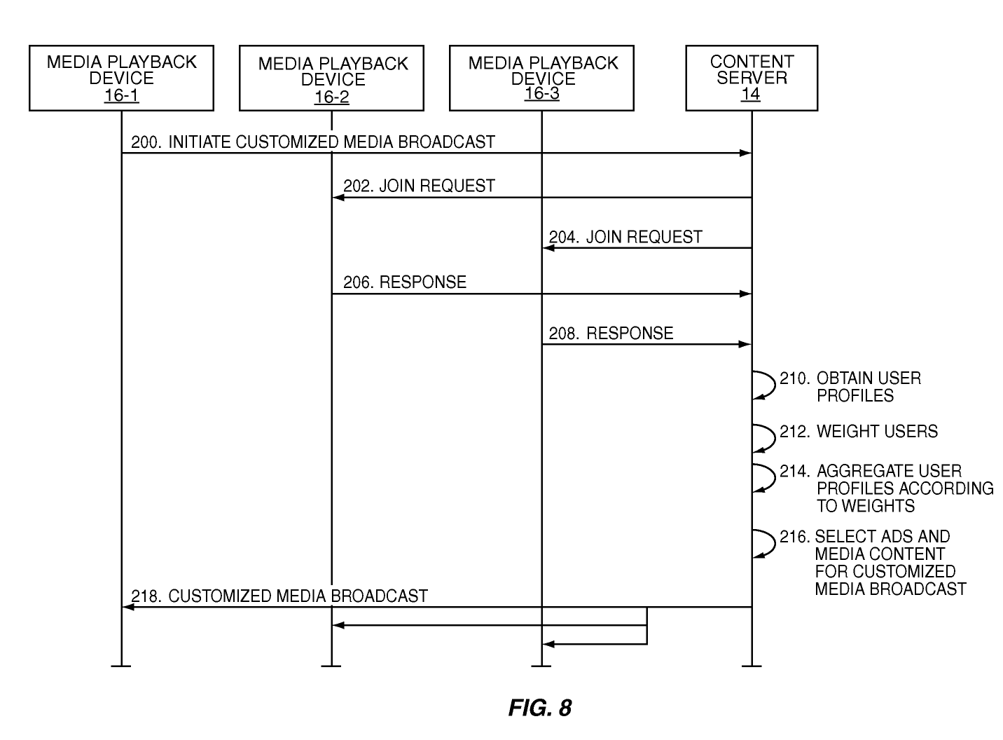

FIG. 8 illustrate the operation of the system 12 of FIG. 7 according to one embodiment of the present invention. First, in this example, the user 18-1 interacts with the media playback device 16-1 to initiate creation of a customized media broadcast (step 200). In one embodiment, the creation of the customized media broadcast is initiated by sending a request including the contact list 40-1 of the user 18-1 to the content server 14. In this example, the contact list 40-1 identifies the users 18-2 and 18-3 as contacts of the user 18-1. However, in another exemplary embodiment, the creation of the customized media broadcast may be initiated by sending a request to the content server 14 including information identifying a number of other users with which the user 18-1 is currently participating in a social networking activity. For example, during a chat session with a number of other users from the users 18-2 through 18-N, the user 18-1 may initiate creation of the customized media broadcast. In response, the media playback device 16-1 may provide a request to the content server 14 including information identifying the other users participating in the chat session with the user 18-1.

In response, the content server 14, and more specifically the broadcast group creation function 26 of the customized media broadcast function 22, sends join requests to the user devices 16-2 and 16-3 of the users 18-2 and 18-3 (steps 202 and 204). Again, the users 18-2 and 18-3 may be the users in identified by the contact list 40-1 of the user 18-1, other users with which the user 18-1 is participating in a social network activity, or the like. In this example, both the user 18-2 and the user 18-3 choose to join the broadcast group. As such, responses indicating that the users 18-2 and 18-3 desire to join the broadcast group are returned to the content server 14 (steps 206 and 208). In response, the broadcast group creation function 26 of the customized media broadcast function 22 of the content server 14 identifies the user 18-1, the user 18-2, and the user 18-3 as users forming the broadcast group.

The profile aggregation function 28 of the customized media broadcast function 22 of the content server 14 then obtains user profiles of the users 18-1, 18-2, and 18-3 forming the broadcast group (step 210). In one embodiment, the user profiles of the users 18-1 through 18-N are hosted by the content server 14 and therefore obtained from local storage. In another embodiment, the user profiles of the users 18-1 through 18-N may be obtained from one or more remote sources such as, for example, the media playback devices 16-1 through 16-N. In this embodiment, the profile aggregation function 28 of the content server 14 weights the users 18-1, 18-2, and 18-3 forming the broadcast group, as discussed above (step 212). The profile aggregation function 28 then aggregates the user profiles of the users 18-1, 18-2, and 18-3 according to the weights assigned to the users 18-1, 18-2, and 18-3 to provide a group profile for the broadcast group (step 214).

The content selection function 30 of the customized media broadcast function 22 of the content server 14 then selects advertisements and/or media content for the customized media broadcast from the ad repository 34 and the media content repository 36, respectively, based on the group profile of the broadcast group (step 216). Using the group profile of FIG. 6B as an example, the customized media broadcast may be a customized radio broadcast including a number of songs selected based on the aggregate weights assigned to the media preferences (e.g., music genres and decades) in the group profile and a number of advertisements selected based on the aggregate weights assigned to the demographics (e.g., income level and gender) in the group profile. The selected media content and advertisements are then arranged to provide the customized media broadcast for the broadcast group. In this embodiment, the streaming function 32 of the customized media broadcast function 22 of the content server 14 then streams the customized media broadcast to the media playback devices 16-1, 16-2, and 16-2 of the users 18-1, 18-2, and 18-3 forming the broadcast group via a multicast communication channel (set 218). As one exemplary alternative, the content server 14 may stream the customized media broadcast to the media playback devices 16-1, 16-2, and 16-3 via separate communication channels.

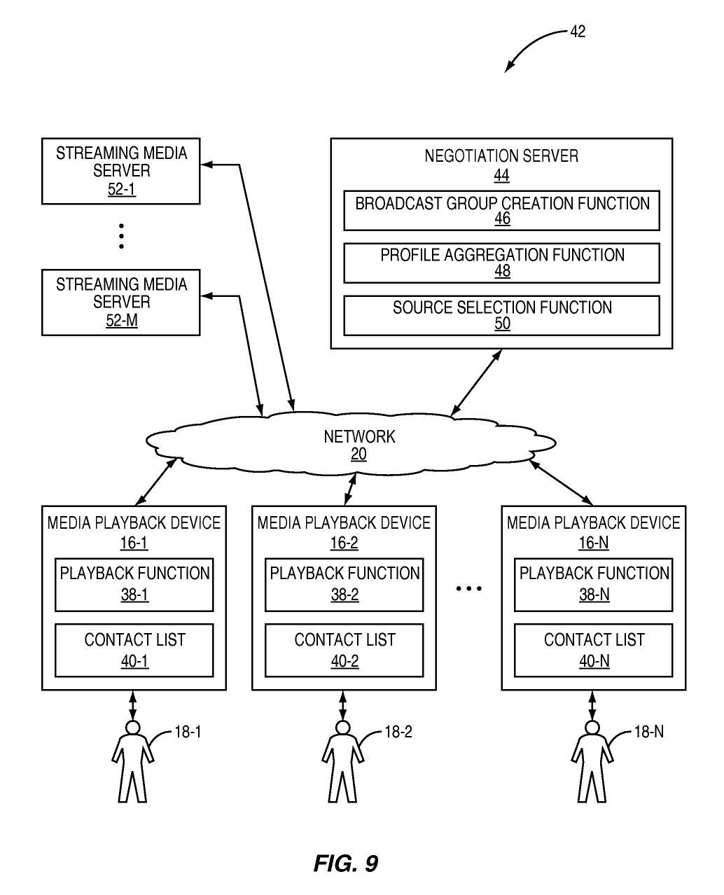

FIG. 9 illustrates a system 42 for providing a customized media broadcast to users in a broadcast group according to another exemplary embodiment of the present invention. The system 42 includes a negotiation server 44 connected to the media playback devices 16-1 through 16-N via the network 20. In this embodiment, the negotiation server 44 includes a broadcast group creation function 46, a profile aggregation function 48, and a source selection function 50, each of which may be implemented in software, hardware, or a combination thereof. In general, the broadcast group creation function 46 operates to identify users from the users 18-1 through 18-N for a broadcast group. The profile aggregation function 48 obtains and aggregates user profiles of the users defined for the broadcast group as discussed above. Based on the group profile of the broadcast group, the source selection function 50 then selects one of a number of streaming media servers 52-1 through 52-M as a source for the customized media broadcast for the broadcast group. The selected streaming media server then delivers the customized media broadcast to the negotiation server 44, which may then stream the customized media broadcast to the media playback devices of the users forming the broadcast group over the network 20. Alternatively, the negotiation server 44 may cause streaming of the customized media broadcast from the selected streaming media server to the media playback devices of the users in the broadcast group over the network 20.

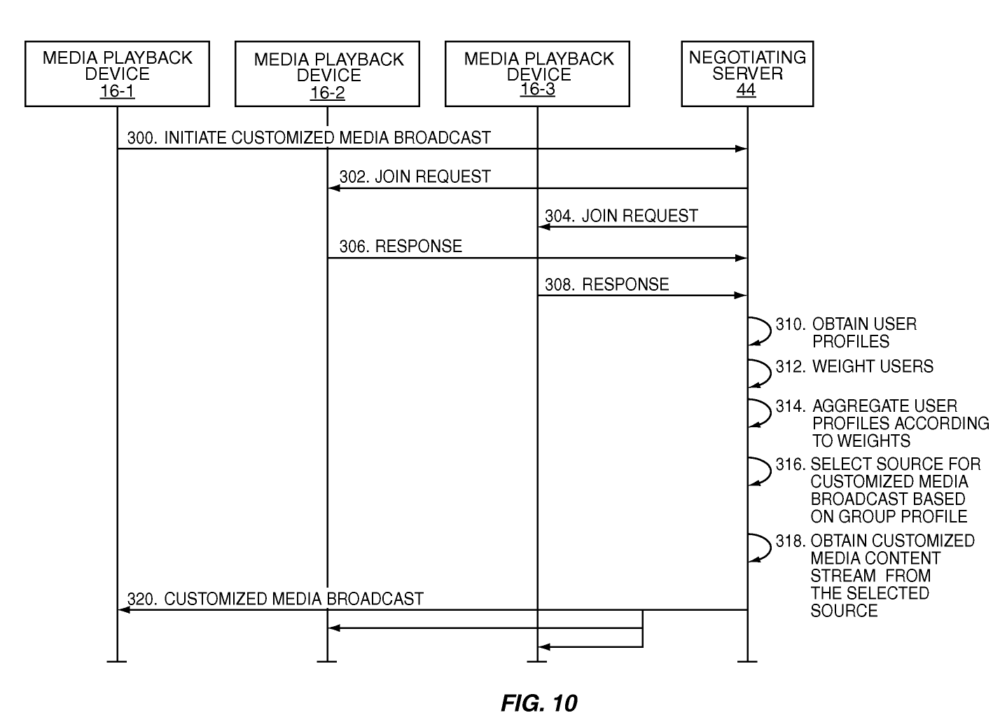

FIG. 10 illustrates the operation of the system 42 of FIG. 9 according to one embodiment of the present invention. First, in this example, the user 18-1 interacts with the media playback device 16-1 to initiate creation of a customized media broadcast, as discussed above (step 300). In response, the negotiation server 44, and more specifically the broadcast group creation function 46, sends join requests to the user devices 16-2 and 16-3 of the users 18-2 and 18-3 (steps 302 and 304). Again, the users 16-2 and 16-3 may be the users in identified by the contact list 40-1 of the user 18-1, other users with which the user 18-1 is participating in a social network activity, or the like. In this example, both the user 18-2 and the user 18-3 choose to join the broadcast group. As such, responses indicating that the users 18-2 and 18-3 desire to join the broadcast group are returned to the negotiation server 44 (steps 306 and 308). In response, the broadcast group creation function 46 of the negotiation server 44 identifies the user 18-1, the user 18-2, and the user 18-3 as users forming the broadcast group.

The profile aggregation function 48 of the negotiation server 44 then obtains user profiles of the users 18-1, 18-2, and 18-3 forming the broadcast group (step 310). In one embodiment, the user profiles of the users 18-1 through 18-N are hosted by the negotiation server 44 and therefore obtained from local storage. In another embodiment, the user profiles of the users 18-1 through 18-N may be obtained from one or more remote sources such as, for example, the media playback devices 16-1 through 16-N. In this embodiment, the profile aggregation function 48 of the negotiation server 44 weights the users 18-1, 18-2, and 18-3 forming the broadcast group, as discussed above (step 312). The profile aggregation function 48 then aggregates the user profiles of the users 18-1, 18-2, and 18-3 according to the weights assigned to the users 18-1, 18-2, and 18-3 to provide a group profile for the broadcast group (step 314).

Based on the group profile for the broadcast group, the source selection function 50 of the negotiation server 44 then selects one of the streaming media servers 52-1 through 52-M as a source for the customized media broadcast for the broadcast group (step 316). More specifically, in one embodiment, the negotiation server 44 provides the group profile of the broadcast group to each of the streaming media servers 52-1 through 52-M. In response, each of the streaming media servers 52-1 through 52-M generates a bid form and returns the bid form to the negotiation server 44. Using the streaming media server 52-1 as an example, in one embodiment, the bid form generated by the streaming media server 52-1 includes a list of media content and advertisements for a proposed customized media broadcast for the broadcast group selected based on the group profile of the broadcast group. Note that the bid form may additionally or alternatively include other information describing or defining the media content and/or advertisements for the proposed customized media broadcast. In addition, the bid form may include an ad time ratio corresponding to a ratio of advertisement time to total playback time for the proposed customized media broadcast. The bid form may also include an advertisement rating for one or more of the advertisements for the proposed customized media broadcast. Still further, the bid form may include a minimum number of users required for the broadcast group. Lastly, the bid form may include a commitment duration defining a period of time that the streaming media server 52-1 will commit to providing the proposed customized media broadcast.

Upon receiving the bid forms from the streaming media servers 52-1 through 52-M, the source selection function 50 of the negotiation server 44 selects one of the streaming media servers 52-1 through 52-M as the source of the customized media broadcast for the broadcast group based on the information contained in the bid forms. For example, the source selection function 50 may select the streaming media server corresponding to the proposed customized media broadcast that most closely matches the group profile of the broadcast group. In addition or alternatively, the source selection function 50 may consider the ad time ratio, the minimum number of users, the commitment duration, or the ad rating for each of the streaming media servers 52-1 through 52-M when selecting the source for the customized media broadcast for the broadcast group. In another embodiment, the source selection function 50 may provide the bid forms, or the information from the bid forms, to the media playback devices 16-1, 16-2, and 16-3 of the users 18-1, 18-2, and 18-3 forming the broadcast group. The information from the bid forms may then be presented to the users 18-1, 18-2, and 18-3 at the media playback devices 16-1, 16-2, and 16-3, and the users 18-1, 18-2, and 18-3 may vote or otherwise select one of the streaming media servers 52-1 through 52-M as the source for the customized media broadcast for the broadcast group.

Assuming that the streaming media server 52-1 is selected as the source of the customized media broadcast for the broadcast group, in this embodiment, the negotiation server 44 then obtains the customized media broadcast from the streaming media server 52-1 (step 318). For example, the negotiation server 44 may request streaming of the customized media broadcast from the streaming media server 52-1 to the negotiation server 44. The negotiation server 44 then delivers the customized media broadcast to the media playback devices 16-1, 16-2, and 16-3 of the users 18-1, 18-2, and 18-3 in the broadcast group (step 320). In this embodiment, the negotiation server 44 streams the customized media broadcast to the media playback devices 16-1, 16-2, and 16-3 via a multicast communication channel. However, the present invention is not limited thereto.

In an alternative embodiment, the negotiation server 44 may cause delivery of the customized media broadcast from the streaming media server 52-1 to the media playback devices 16-1, 16-2, and 16-3 of the users 18-1, 18-2, and 18-3 in the broadcast group. For example, the negotiation server 44 may cause the media playback devices 16-1, 16-2, and 16-3 to request the customized media broadcast from the streaming media server 52-1. In response, the streaming media server 52-1 may stream the customized media broadcast to the media playback devices 16-1, 16-2, and 16-3 via separate communication channels or a multicast communication channel. As another example, the negotiation server 44 may instruct the streaming media server 52-1 to stream the customized media broadcast to the user devices 16-1, 16-2, and 16-3 via separate communication channels or a multicast communication channel.

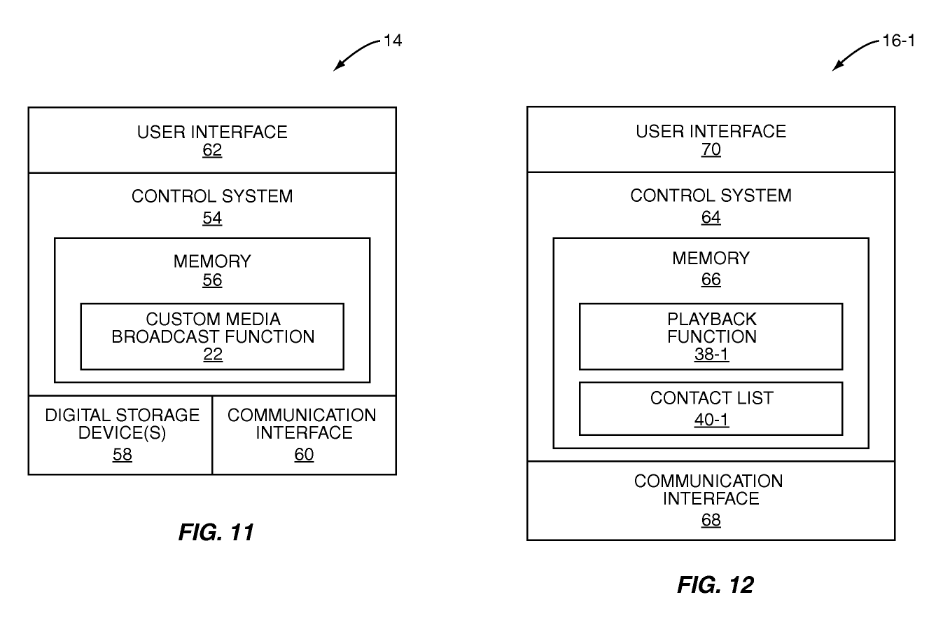

FIG. 11 is a block diagram of the content server 14 of FIG. 7 according to one embodiment of the present invention. In general, the content server 14 includes a control system 54 having associated memory 56. In this example, the customized media broadcast function 22 is implemented in software and stored in the memory 56. However, the present invention is not limited thereto. The customized media broadcast function 22 may be implemented in software, hardware, or a combination thereof. In addition, the content server 14 may include one or more digital storage devices 58 such as, for example, one or more hard disk drives. In one embodiment, the ad repository 34 and the media content repository 36 are stored by the one or more digital storage devices 58. However, the present invention is not limited thereto. The content server 14 also includes a communication interface 60 communicatively coupling the content server 14 to the network 20 (FIG. 7). Lastly, the content server 14 may include a user interface 62, which may include components such as, for example, a display, one or more user input devices, or the like.

FIG. 12 is a block diagram of the media playback device 16-1 of FIGS. 7 and 9 according to one embodiment of the present invention. This discussion is equally applicable to the other media playback devices 16-2 through 16-N. In general, the media playback device 16-1 includes a control system 64 having associated memory 66. In this example, the playback function 38-1 is implemented in software and stored in the memory 66. However, the present invention is not limited thereto. The playback function 38-1 may be implemented in software, hardware, or a combination thereof. The contact list 40-1 may also be stored in the memory 66. The media playback device 16-1 also includes a communication interface 68 communicatively coupling the media playback device 16-1 to the network 20 (FIGS. 7 and 9). Lastly, the media playback device 16-1 includes a user interface 70, which may include components such as, for example, a display, one or more speakers, one or more user input devices, or the like.

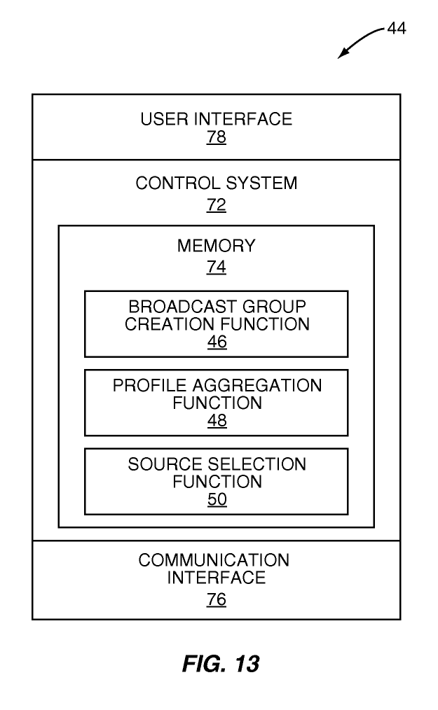

FIG. 13 is a block diagram of the negotiation server 44 of FIG. 9 according to one embodiment of the present invention. In general, the negotiation server 44 includes a control system 72 having associated memory 74. In this example, the broadcast group creation function 46, the profile aggregation function 48, and the source selection function 50 are implemented in software and stored in the memory 74. However, the present invention is not limited thereto. The broadcast group creation function 46, the profile aggregation function 48, and the source selection function 50 may each be implemented in software, hardware, or a combination thereof. In addition, the negotiation server 44 also includes a communication interface 76 communicatively coupling the negotiation server 44 to the network 20 (FIG. 9). Lastly, the negotiation server 44 may include a user interface 78, which may include components such as, for example, a display, one or more user input devices, or the like.

The present invention provides substantial opportunity for variation without departing from the spirit or scope of the present invention. For example, the discussion above focuses on the scenario where each of the users 18-1 through 18-N is associated with a corresponding one of the media playback devices 16-1 through 16-N. However, the present invention is not limited thereto. Multiple users may be associated with a single media playback device. For example, multiple users may be associated with a single network-enabled audio system. As such, those users may be identified as a broadcast group. The profiles of those users may be obtained and aggregated at the audio system, a negotiation server, or a content server, as discussed above. Note that if the locations of the users are needed for weighting the users, the locations of the users may be obtained from corresponding mobile devices such as, for example, GPS-enabled mobile phones of the users. A customized media broadcast may then be delivered to the broadcast group at the audio system.

Those skilled in the art will recognize improvements and modifications to the preferred embodiments of the present invention. All such improvements and modifications are considered within the scope of the concepts disclosed herein and the claims that follow.

What is claimed is:

1. A method comprising:
identifying a group comprising a plurality of users;
obtaining user profiles of the plurality of users;
assigning weights to the plurality of users;
aggregating the user profiles of the plurality of users according to the weights assigned to the plurality of users to provide a group profile for the group; and
delivering customized data to the plurality of users based on the group profile

2. The method of claim 1 wherein assigning the weights to the plurality of users comprises:
obtaining locations of the plurality of users;
determining a group center of the group based on the locations of the plurality of users;
determining distances between the plurality of users and the group center; and
for each user of the plurality of users, assigning the weight to the user as a function of the distance between the user and the group center.

3. The method of claim 2 wherein the weights assigned to the plurality of users are inversely related to the distances between the plurality of users and the group center.

4. The method of claim 2 wherein the group center is a center of gravity of the group.

5. The method of claim 2 wherein determining the group center comprises determining the group center of the group based on the equation:
$$GroupCenter = \frac{1}{N} \cdot {\sum }_{i = 1}^{N} {r}_{i} ,$$
where N is the number of users in the plurality of users and rᵢ is the location of the i^{th} user.

6. The method of claim 1 wherein assigning the weights to the plurality of users comprises, for each user of the plurality of users, assigning the weight to the user as a function of a number of other users from the plurality of users in the group that are identified as contacts of the user.

7. The method of claim 1 wherein assigning the weights to the plurality of users comprises, for each user of the plurality of users, assigning the weight to the user as a function of a number of contacts of the user that are not in the group.

8. The method of claim 1 wherein assigning the weights to the plurality of users comprises, for each user of the plurality of users, assigning the weight to the user as a function of a number of contacts of the user.

9. The method of claim 1 wherein assigning the weights to the plurality of users comprises, for each user of the plurality of users, assigning the weight to the user as a function of two or more of a group consisting of: a number of other users from the plurality of users in the group that are identified as contacts of the user, a number of contacts of the user that are not in the group, and a number of contacts of the user.

10. The method of claim 1 wherein assigning the weights to the plurality of users comprises, for each user of the plurality of users, assigning the weight to the user as a function of one or more of a group consisting of: a number of users with which the user has a direct social network relationship, a number of users with which the user has an indirect social network relationship, a number of users with which the user has a direct or indirect social network relationship, a number of other users that are directly related to the user via a social network and in the group, a number of other users that are indirectly related to the user via the social network and in the group, a number of other users that are directly related to the user via the social network and not in the group, and a number of other users that are indirectly related to the user via the social network and not in the group.

11. The method of claim 1 wherein assigning the weights to the plurality of users comprises assigning the weights to the plurality of users based on one or more demographic criteria.

12. The method of claim 11 wherein the one or more demographic criteria comprise income level.

13. The method of claim 1 wherein assigning the weights to the plurality of users comprises assigning the weights to the plurality of users based on locations of the plurality of users.

14. The method of claim 1 wherein assigning the weights to the plurality of users comprises assigning the weights to the plurality of users based on a status of each of the plurality of users.

15. The method of claim 1 wherein assigning the weights to the plurality of users comprises assigning the weights to the plurality of users based on an amount of time each of the plurality of users has been participating in the group.

16. The method of claim 1 wherein the group is a broadcast group and delivering the customized data comprising delivering a customized media broadcast to the plurality of users based on the group profile of the broadcast group.

17. The method of claim 16 wherein the customized media broadcast comprises media content selected based on the group profile.

18. The method of claim 17 wherein the media content comprises audio content.

19. The method of claim 18 wherein the audio content comprises music.

20. The method of claim 17 wherein the customized media broadcast further comprises a plurality of advertisements selected based on the group profile of the broadcast group.

21. The method of claim 16 wherein the customized media broadcast comprises a plurality of advertisements selected based on the group profile of the broadcast group.

22. The method of claim 1 wherein delivering the customized media broadcast comprises streaming the customized media broadcast to media playback devices of the plurality of users in the broadcast group.

23. The method of claim 22 wherein streaming the customized media broadcast comprises streaming the customized media broadcast to the media playback devices of the plurality of users in the broadcast group via a multicast communication channel.

24. The method of claim 16 wherein delivering the customized media broadcast comprises:
selecting a source for the customized media broadcast from a plurality of potential sources based on the group profile of the broadcast group;
obtaining the customized media broadcast from the source; and
providing the customized media broadcast to the plurality of users in the broadcast group.

25. The method of claim 24 wherein providing the customized media broadcast to the plurality of users comprises streaming the customized media broadcast to media playback devices of the plurality of users in the broadcast group.

26. The method of claim 25 wherein streaming the customized media broadcast comprises streaming the customized media broadcast to the media playback devices of the plurality of users in the broadcast group via a multicast communication channel.

27. The method of claim 16 wherein delivering the customized media broadcast comprises:
selecting a source for the customized media broadcast from a plurality of potential sources based on the group profile of the broadcast group; and
causing the customized media broadcast to be provided from the source to the plurality of users in the broadcast group.

28. The method of claim 27 wherein causing the customized media broadcast to be provided from the source to the plurality of users in the broadcast group comprises instructing the source to stream the customized media broadcast to media playback devices of the plurality of users in the broadcast group.

29. The method of claim 27 wherein causing the customized media broadcast to be provided from the source to the plurality of users in the broadcast group comprises causing media playback devices of the plurality of users in the broadcast group to request streaming of the customized media broadcast from the source to the media playback devices.

30. The method of claim 16 wherein each of the user profiles comprises at least one of a group consisting of: media preferences of a corresponding user of the plurality of users and demographics describing the corresponding user of the plurality of users.

31. The method of claim 30 wherein the group profile comprises at least one of a group consisting of: an aggregate of the media preferences of each of the plurality of users and an aggregate of the demographics describing each of the plurality of users.

32. The method of claim 1 wherein delivering the customized data comprises delivering the customized data to the plurality of users via a wireless network.

33. The method of claim 32 wherein the wireless network is selected from a group consisting of: a 2G wireless telecommunications network, a 3G wireless telecommunications network, a 3.5G wireless telecommunications network, a Long Term Evolution (LTE) wireless telecommunications network, and a WiMax wireless telecommunications network.

34. A server comprising:
a communication interface communicatively coupling the server to a network; and
a control system associated with the communication interface and adapted to:
identify a group comprising a plurality of users;
obtain user profiles of the plurality of users;
assign weights to the plurality of users;
aggregate the user profiles of the plurality of users according to the weights assigned to the plurality of users to provide a group profile for the group;
generate customized data for the plurality of users in the group based on the group profile; and
deliver the customized data to at least one device of the plurality of users via the network.

35. A server comprising:
a communication interface communicatively coupling the server to a network; and
a control system associated with the communication interface and adapted to:
identify a group comprising a plurality of users;
obtain user profiles of the plurality of users;
assign weights to the plurality of users;
aggregate the user profiles of the plurality of users according to the weights assigned to the plurality of users to provide a group profile for the group;
select one of a plurality of potential sources as a source for customized data for the group;
obtain the customized data from the source; and
deliver the customized data to at least one device of the plurality of users via the network.

36. A server comprising:
a communication interface communicatively coupling the server to a network; and
a control system associated with the communication interface and adapted to:
identify a group comprising a plurality of users;
obtain user profiles of the plurality of users;
assign weights to the plurality of users;
aggregate the user profiles of the plurality of users according to the weights assigned to the plurality of users to provide a group profile for the group;
select one of a plurality of potential sources as a source for customized data for the broadcast group; and
cause the customized data to be delivered from the source to at least one device of the plurality of users via the network.
